(19) United States
(12) Patent Application Publication
(10) Pub. No.: US 2014/0094174 A1
(43) Pub. Date: Apr. 3, 2014

(54) CONTROLLING HANDOVER OF A MOBILE STATION FROM E-UTRAN TO UTRAN/GERAN CIRCUIT SWITCHED IN A MULTI-OPERATOR CORE NETWORK

(71) Applicant: TELEFONAKTIEBOLAGET L M ERICSSON (PUBL), Stockholm (SE)

(72) Inventors: John Walter Diachina, Garner, NC (US); Paul Schliwa-Bertling, Ljungsbro (SE)

(73) Assignee: TELEFONAKTIEBOLAGET L M ERICSSON (PUBL), Stockholm (SE)

(21) Appl. No.: 13/904,437

(22) Filed: May 29, 2013

Related U.S. Application Data
(60) Provisional application No. 61/708,318, filed on Oct. 1, 2012.

(51) Int. Cl. H04W 36/34

(52) U.S. Cl. CPC H04W 36/34
USPC 455/436

(57) ABSTRACT

A method by a target UTRAN or target GERAN operating in CS domain to control handover of a MS from a source RAN. The method includes receiving a handover request message from a MSC server as a result of handover triggered by the source RAN. The handover request message identifies a selected PLMN identity (ID) that will serve the MS after handover. A corresponding PLMN ID index is generated that indicates an association between the selected PLMN ID and one of a plurality of PLMN IDs of a set transmitted as system information on a Broadcast Control Channel (BCCH) by the target UTRAN or target GERAN. A handover response containing the PLMN ID index is communicated toward the MSC server for subsequent forwarding to the MS by the source RAN. Related mobile stations and methods are disclosed.

### RELATED APPLICATIONS

The present application claims the benefit of priority from U.S. Provisional Application No. 61/708,318 entitled “PLMN ID Index Support for Handover to CS in MOCN” filed Oct. 1, 2012, the disclosure of which is hereby incorporated herein in its entirety by reference.

### TECHNICAL FIELD

The present disclosure relates to radio access networks and, more particularly, to handover to a circuit switched radio access network in a multi-operator core network.

### BACKGROUND

With the introduction of the FULL-Multi-Operator Core Network (FULL-MOCN) feature a common radio access network (RAN, e.g. a BSS) will be shared by multiple Mobile Switching Centres (MSCs) and/or Serving GPRS Support Nodes (SGSNs), where each MSC and/or SGSN is associated with a different Public Land Mobile Network (PLMN) identified using a unique PLMN ID value. When a Mobile Station (MS) is operating in an Evolved Universal Terrestrial Radio Access Network (E-UTRAN) service area and experiences Packet Switched (PS) domain to Circuit Switched (CS) domain Single Radio Voice Call Continuity (SRVCC), (e.g., handover from E-UTRAN PS domain to the CS domain of a GSM cell), or experiences a CS to CS handover (e.g., from a source GSM cell to a target GSM cell) where FULL-MOCN is supported, various operational problems can occur.

When PS domain to CS domain SRVCC occurs, the MS necessarily experiences an inter-Radio Access Technology (RAT) handover which triggers the MS to perform a Routing Area Update (RAU) upon arriving in the new cell (managed by the target RAN) in order to update network nodes in the PS domain. The MS may also need to perform a RAU following CS domain to CS domain handover.

As part of the RAU procedure, the MS transmits a RAU Request message to the target RAN. The target RAN should forward the RAU Request message to the correct SGSN based on the PLMN ID that was selected by the source RAN (when it first triggers SRVCC or CS to CS handover) for use by the MS in the new cell. However, this becomes problematic for PS to CS SRVCC and CS to CS handover to a target RAN that supports FULL-MOCN because there will be no process for the target RAN to determine the SGSN to which it should forward the RAU Request message because it will not be able to associate the MS sending this message with any specific PLMN. The target RAN therefore may forward the RAU Request message to a SGSN that is not associated with the PLMN selected by the source RAN, which may result in the MS receiving less than optimal service. For example, the MS may be billed excessively for all PS domain traffic transacted while being served by the SGSN associated with the less preferred PLMN.

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

### SUMMARY

To address the foregoing problems identified in the prior art, the Detailed Description presented hereinafter will describe several systems and methods directed to controlling handover of a MS from a source RAN to a target UTRAN or target GSM EDGE Radio Access Network (GERAN) operating in CS domain.

One embodiment is directed to a method by a target UTRAN or target GERAN operating in CS domain to control handover of a MS from a source RAN. The method includes receiving a handover request message from a MSC server as a result of handover triggered by the source RAN. The handover request message identifies a selected PLMN identity (ID) that will serve the MS after handover. A corresponding PLMN ID index is generated that indicates an association between the selected PLMN ID and one of a plurality of PLMN IDs of a set transmitted as system information on a Broadcast Control Channel (BCCH) by the target UTRAN or target GERAN. A handover response containing the PLMN ID index is communicated toward the MSC server for subsequent forwarding to the MS by the source RAN.

A potential benefit that may be provided by this and other embodiments disclosed herein is that the target UTRAN or target GERAN can use the PLMN ID index communicated to the MS, via the handover response, to indicate which one of the plurality of PLMN IDs transmitted as system information by the target UTRAN or target GERAN corresponds to the PLMN ID selected for the MS. Upon arrival in the new cell as a result of executing handover the MS communicates the PLMN ID index back to the target UTRAN or target GERAN when performing a RAU update, which enables the target UTRAN or target GERAN to forward the RAU Request message to the SGSN corresponding to the PLMN ID index, which may result in the MS receiving more optimal service.

Another embodiment is directed to a method by a MS for controlling handover from a source RAN to a target UTRAN or target GERAN operating in CS domain. The method includes receiving a handover command from the source RAN. The handover command contains a PLMN ID index. Handover is executed to the target UTRAN or target GERAN. A determination is made that a routing area update (RAU) is needed. A RAU Request message is communicated toward the target UTRAN or target GERAN with the PLMN ID index carried by a RLC protocol used to communicate the RAU Request message.

Other methods, UTRAN nodes, GERAN nodes, and MSs according to embodiments of the invention will be or become apparent to one with skill in the art upon review of the following drawings and detailed description. It is intended that all such additional methods, UTRAN nodes, GERAN nodes, and MSs be included within this description, be within the scope of the present invention, and be protected by the accompanying claims. Moreover, it is intended that all embodiments disclosed herein can be implemented separately or combined in any way and/or combination.

### BRIEF DESCRIPTION OF THE DRAWINGS

Aspects of the present disclosure are illustrated by way of example and are not limited by the accompanying drawings. In the drawings:

FIG. 1 is a block diagram of a radio telecommunications network that is configured to operate according to some embodiments;

FIG. 2 illustrates a diagram of operations, methods and associated message flows between various network nodes of the radio telecommunications network of FIG. 1 for controlling handover of a MS from an E-UTRAN source cell in a PS domain to a target UTRAN cell or target GERAN cell in a CS domain according to some embodiments;

FIG. 3 illustrates a diagram of operations, methods and associated message flows between various network nodes of the radio telecommunications network of FIG. 1 for further controlling handover of a MS from an E-UTRAN source cell in a PS domain to a target UTRAN cell or target GERAN cell in a CS domain according to some embodiments;

FIG. 4 illustrates a diagram of operations, methods and associated message flows between various network nodes of the radio telecommunications network of FIG. 1 for controlling handover of a MS from source UTRAN cell or source GERAN cell in a CS domain to a target UTRAN cell or target GERAN cell in a CS domain according to some embodiments;

FIG. 5 is a block diagram of an example RAN of FIGS. 1-4 that is configured according to some embodiments; and

FIG. 6 is a block diagram of an example MS of FIGS. 1-4 that is configured according to some embodiments.

### DETAILED DESCRIPTION

Embodiments of the present disclosure will be described more fully hereinafter with reference to the accompanying drawings. Other embodiments may take many different forms and should not be construed as limited to the embodiments set forth herein. Like numbers refer to like elements throughout.

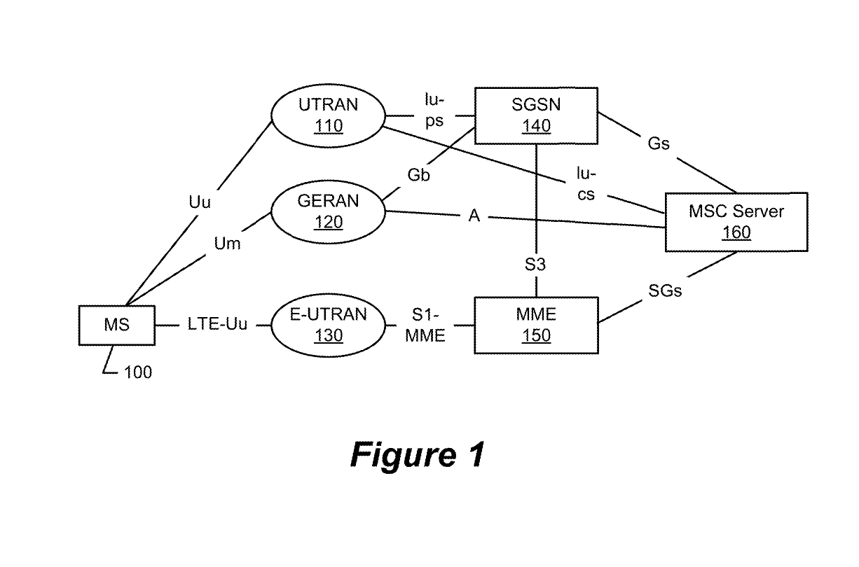

One or more of foregoing problems may be overcome by various embodiments disclosed herein. Some embodiments are disclosed in the context of an example Third Generation Partnership Project (3GPP) radio telecommunications network shown in FIG. 1. An overview of the network of FIG. 1 is initially provided, and then various operations according to embodiments disclosed herein are explained in the context of the network of FIG. 1. Although various embodiments are disclosed in the context of the network of FIG. 1, the invention is not limited thereto.

The radio telecommunications network comprises a plurality, typically thousands, of MSs 100 (also known as user equipment nodes, wireless terminals, or mobile stations) that communicate through radio access communication links with a UTRAN 110, a GERAN 120, and/or an E-UTRAN 130.

The UTRAN 110/GERAN 120 can include a radio network controller (RNC)/base station controller (BSC) nodes to control communications through radio base station nodes providing radio access communication links to MSs 100 that are within their respective communication service cells. The E-UTRAN 130 can include radio base station nodes (eNodeBs) that can provide the combined functionality of the RNC/BSC nodes of the UTRAN 110/GERAN 120.

A plurality of SGSNs 140 (one of which is shown in FIG. 1) are responsible for the delivery of data packets from and to the MSs 100 within their geographical service area. Their tasks can include packet routing and transfer, mobility management (attach/detach and location management), logical link management, and authentication functions. The SGSNs 140 control communications connections between MSs 100 and one or more packet-based networks, and may perform other functions such as mobility management of MSs 100. Mobility Management Entities (MMEs) 150 (one of which is shown in FIG. 1) and the SGSNs 140 provide control plane functionality to enable mobility of MSs 100 between the UTRAN 110, the GERAN 120, and the E-UTRAN 130 via the S3 interface between the MMEs 150 and the SGSNs 140.

The MMEs 150 route and forward signalling packets for the E-UTRAN 130, and are responsible for EPS Connection Management (ECM) idle mode MS 100 tracking and paging procedures, and are involved in connection bearer (Packet Data Network (PDN) connection) activation/deactivation processes, for choosing a Serving Gateway (SGW) for a MS 100 at the initial attachment and at time of handover.

Some embodiments disclosed herein are directed to modifying the legacy PS domain to CS domain SRVCC (e.g. handover from E-UTRAN PS domain to the CS domain of a GERAN/UTRAN cell) procedure where FULL-MOCN is supported. The SRVCC procedure can be based on the standards document 3GPP TS 23.207, with additional procedural steps as disclosed here. Some other related embodiments are directed to modifying the CS domain to CS domain handover procedure (e.g. from a source GERAN/UTRAN cell to a target GERAN/UTRAN cell) where FULL-MOCN is supported. For facilitating session transfer (SRVCC) of the voice component from the PS domain of E-UTRAN to the CS domain, the IMS multimedia telephony sessions needs to be anchored in the IMS.

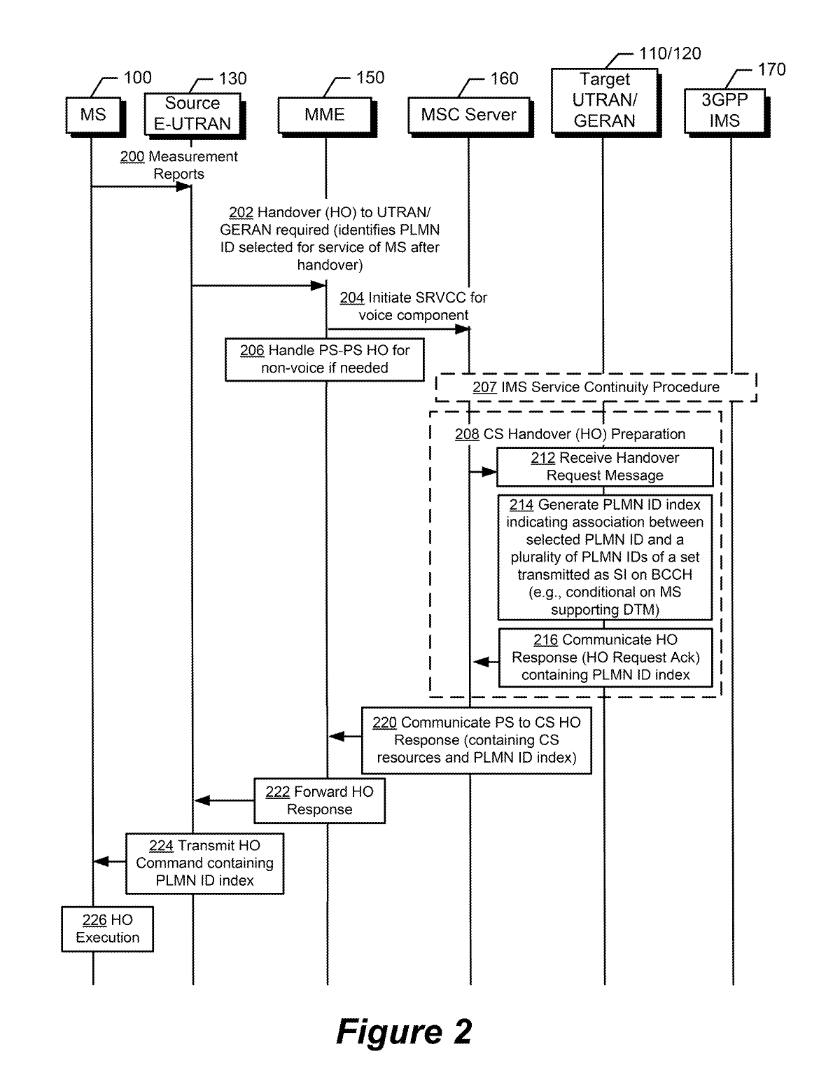

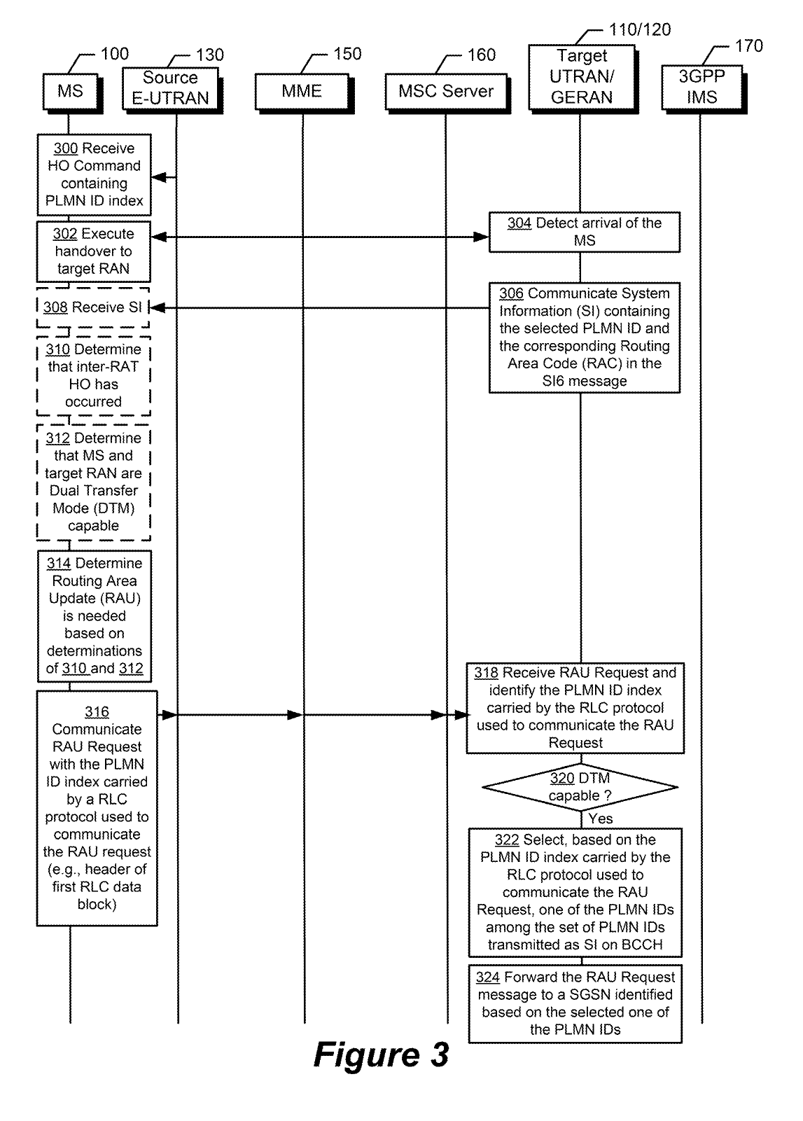

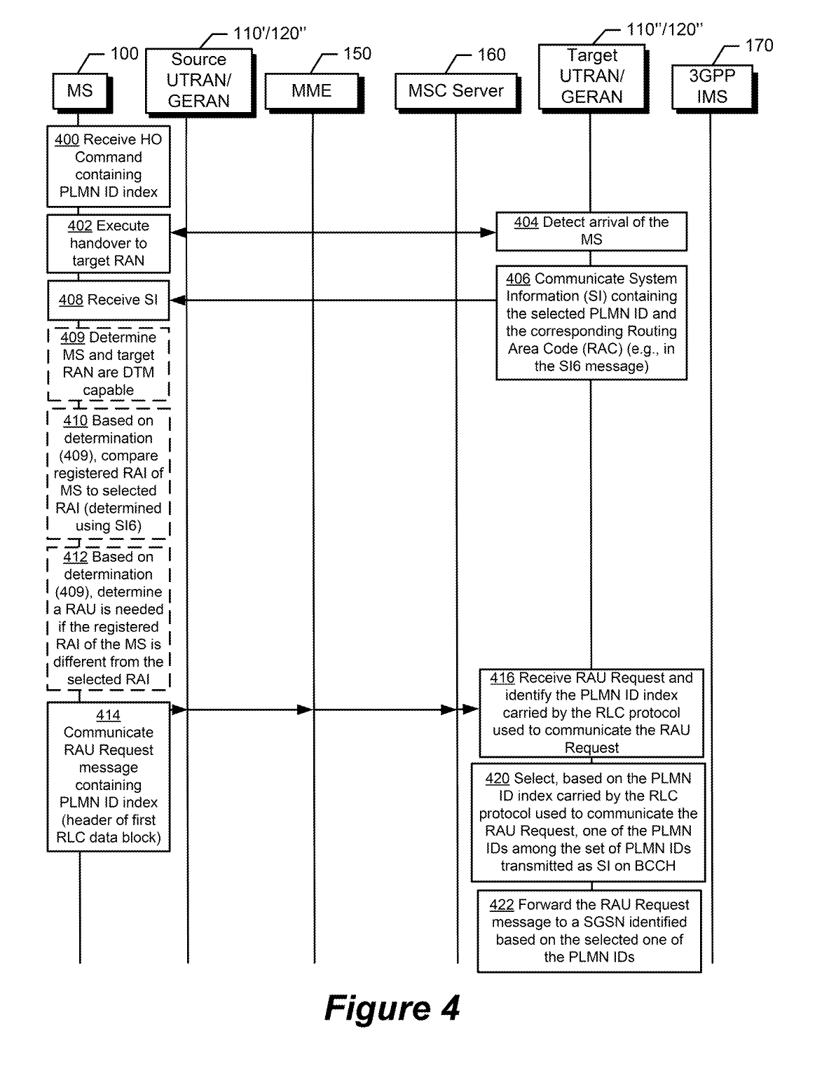

Some embodiments are initially described below in the context of PS domain to CS domain SRVCC with regard to FIGS. 2 and 3. Other embodiments are then described further below in the context of CS domain to CS domain handover with regard to FIG. 4.

FIGS. 2 and 3 illustrate related diagrams of operations, methods and associated message flows between various network nodes of the radio telecommunications network of FIG. 1 for controlling handover of a MS from an E-UTRAN source cell in a PS domain to a target UTRAN cell or target GERAN cell in a CS domain according to some embodiments.

Referring to FIG. 2, the MS 100 is served by the E-UTRAN 130 during a call in the PS domain. The MS 100 provides measurement reports 200 to the E-UTRAN 130. The E-UTRAN 130 determines from the measurement reports 200 that SRVCC needs to be performed to either the target UTRAN 110 or target GERAN 120. The E-UTRAN 130 communicates a handover required message 202, which identifies a PLMN identity (ID) selected for service of the MS 100 after handover.

The MME 150 receives the handover required message 202 from the E-UTRAN 130 with an indication that the handover is for SRVCC handling. The MME 150 then communicates a message 204, to trigger the SRVCC procedure for the voice component of the call, to the MSC server 160 which is enhanced for SRVCC via the Sy reference point if the MME 150 has a Session Transfer Number for SRVCC (STN-SR) information for the MS 100. If SRVCC with priority is supported, based on the Allocation and Retention Priority (ARP) associated with the Evolved Packet System (EPS) bearer used for IP Multimedia Subsystem (IMS) signalling, the MME 150 sets the priority indication appropriately toward the MSC server 160. The MME 150 is aware of which EPS bearer is used for IMS signalling based on a known local configuration.

The MSC server 160, enhanced for SRVCC, then initiates the session transfer procedure to IMS and coordinates the procedure with the CS handover procedure to the target cell (target UTRAN 110 or target GERAN 120). This procedure is illustrated as CS handover preparation, block 208.

The target UTRAN 110 or target GERAN 120 (abbreviated “target UTRAN 110/GERAN 120) allocates the requested resources and returns the applicable parameters to the MSC server 160 in a handover response, called a Handover Request Acknowledge. However, in accordance with one embodiment, content of the Handover Request Acknowledge is modified to include a PLMN ID index that is subsequently communicated to the MS 100 within the Handover Command (224). When the MS 100 subsequently performs a RAU after handover to the target UTRAN 110/GERAN 120, the MS 100 includes the PLMN ID index carried by the RLC protocol used to communicate a RAU Request message. The target UTRAN 110/GERAN 120 receiving the RAU Request message then uses the PLMN ID index to identify one of the SGSNs 140, or other network node, that is associated with the PLMN selected by the source E-UTRAN (130) to serve the MS 100 in the new cell. The target UTRAN 110/GERAN 120 forwards the RAU Request message to the identified SGSN 140, which may result in the MS 100 receiving more optimal service. For example, the MS 100 may be properly billed according to expectations with the earlier selected PLMN for PS domain traffic transacted after the handover.

With further reference to the non-limiting example of FIG. 2, the target UTRAN 110/GERAN 120 receives (block 212) the handover request message from the MSC server 160 as a result of handover triggered by the source E-UTRAN (130), where the handover request message identifies a selected PLMN ID that will serve the MS 100 after handover. The selected PLMN ID may be indicated by a target cell ID contained in the handover request message, which the target UTRAN 110/GERAN 120 can be configured to use to determine the PLMN and LAC selected for service by the source E-UTRAN (130). The target UTRAN 110/GERAN 120 (e.g., BSS) is aware that FULL-MOCN operation is supported and therefore realizes that a PLMN ID index corresponding to the selected PLMN ID may be needed by the MS 100 when it arrives in the target cell as a result of PS to CS SRVCC (e.g. if Dual Transfer Mode (DTM) is supported in the target cell).

The target UTRAN 110/GERAN 120 may also be able to identify the selected PLMN ID associated with the MSC server 160 from which it receives the handover request (also referred to as as the selected PLMN ID), and has knowledge of the set of PLMN IDs being transmitted as part of SI. The target UTRAN 110/GERAN 120 can therefore determine that the selected PLMN ID that has been indicated to it (either explicitly indicated by a target cell ID included in the handover request or implicitly indicated by the MSC sending the handover request) maps to one of the PLMN IDs that it is currently transmitting as part of SI in the target cell, and can generate a PLMN ID index value that corresponds to the selected PLMN ID. The PLMN ID index therefore identifies a selected PLMN ID corresponding to one of a plurality of different operators of a FULL-MOCN that is serving the MS 100.

In one embodiment, the target UTRAN 110/GERAN 120 generates (block 214) a PLMN ID index that indicates an association between the selected PLMN ID and one of a plurality of PLMN IDs of a set transmitted as SI by the target UTRAN 110/GERAN 120 on the Broadcast Control Channel (BCCH), which generation/communication can be conditional based on a determination that the MS 100 supports DTM . The set of the PLMN IDs can be an ordered list of PLMN IDs, so that the PLMN ID index can be generated based on a location of the PLMN ID in the ordered list of PLMN IDs. Thus, for example, the PLMN ID index can be set to 3 if the target PLMN ID is the 3rd PLMN ID in the list of PLMN IDs being transmitted as part of SI in the target cell. Similarly, the PLMN ID index can be set to another integer “n” if the target PLMN ID is the nth PLMN ID in the list of PLMN IDs being transmitted as part of SI in the target cell.

The target UTRAN 110/GERAN 120 communicates (block 216) a handover response containing the PLMN ID index toward the MSC server 160 for subsequent forwarding to the MS 100. The handover response can be a Handover Request Acknowledge containing the PLMN ID index. The PLMN ID index can be embedded in a transparent container carried (transported) within the Handover Request Acknowledge. The target UTRAN 110/GERAN 120 can determine that itself and the MS 100 are DTM capable as a precondition for communicating any PLMN ID index in the handover response (e.g., within a defined transparent container of the Handover Request Acknowledge) for the MS 100.

In another embodiment, in the case where a GWCN (Gateway Core Network) architecture is used (i.e. SGSNs 140 and MSC servers 160 are shared by multiple PLMNs) the MSC server 160 indicates the selected PLMN ID within a legacy information element as discussed above, in the Handover Request message sent to the target UTRAN 110/GERAN 120. The target UTRAN 110/GERAN 120 can determine the corresponding PLMN ID index as described above using information from the legacy Information Element.

Accordingly, the target UTRAN 110/GERAN 120 (BSS) includes the PLMN ID index as new information within a legacy transparent container sent from the target UTRAN 110/GERAN 120 (BSS) to the source E-UTRAN 130 (source eNodeB) during the PS to CS SRVCC procedure. The MSC server 160 allocates CS resources for use by the MS 100 after handover, and communicates a PS to CS handover response (block 220) that contains information identifying the CS resources, and further contains the transparent container having the PLMN ID index. The MME 150 receives and forwards (block 222) the PS handover response to the source E-UTRAN 130 (source eNodeB). The source E-UTRAN 130 (source eNodeB) transmits (block 224) a CS handover command containing the PLMN ID index to the MS 100 in the serving E-UTRAN 130 cell.

The MSC server 160, the target UTRAN 110/GERAN 120, and a 3GPP IMS 170 may also perform an IMS service continuity procedure (block 207) according to established standards. If SRVCC with priority is supported, IMS service continuity procedure (session transfer procedure) and the CS handover procedure are performed with priority handling per the priority indication received from MME 150 with the handover request message. The MSC server 160 enhanced for SRVCC then sends a PS-CS handover Response to the MME 150, which includes the necessary CS handover command information for the MS 100 to access the target UTRAN 110/GERAN 120.

Handling of any non-voice PS bearer (block 206) is done by a PS bearer splitting function in the MME 150. The MME 150 starts the handover of non-voice PS bearer during SRVCC procedure based on the information received from E-UTRAN. The handover of non-voice PS bearer(s), if performed, may be performed according to Inter RAT handover procedures defined in 3GPP specification TS 23.401. The MME 150 is responsible for coordinating the Forward Relocation Response from PS-PS handover procedure and the SRVCC PS to CS Response.

The MS 100 identifies the PLMN ID index in a transparent container carried within the handover command (block 224 of FIG. 2, block 300 of FIG. 3). The MS 100 executes handover (block 302) by moving to the indicated UTRAN 110/GERAN 120 target cell, and if the MS 100 determines that a RAU is needed it includes the PLMN ID index, which it received in the handover command, in the header of the first Radio Link Control (RLC) data block of the RLC protocol used to communicate the RAU message (RAU Request message) to the target UTRAN 110/GERAN 120.

Operations, methods and associated message flows between the MS 100 and target UTRAN 110/GERAN 120 to complete PS to CS handover and perform a subsequent RAU are shown in FIG. 3 according to some embodiments. Referring to FIG. 3, the MS 100 receives (block 300) the handover command (block 224 of FIG. 2) containing the PLMN ID index, and executes handover (block 226 of FIG. 2, block 302 of FIG. 3) by moving to the indicated target UTRAN 110/GERAN 120 cell and communicating therewith. The target UTRAN 110/GERAN 120 detects (block 304) arrival of the MS 100. The target UTRAN 110/GERAN 120 communicates (block 306) System Information (SI) containing the selected PLMN ID and the corresponding Routing Area Code (RAC) using a Fast Associated Control Channel (FACCH) of the CS resource used by the MS 100 in the new cell. In a further embodiment, the selected PLMN ID and the RAC are communicated (block 306) in system information 6 (SI6) message sent on the FACCH.

The MS 100 determines (block 314) whether a routing area update (RAU) is needed, and, if so, communicates (block 316) a RAU Request message toward the target UTRAN 110/GERAN 120 with the PLMN ID index carried by the RLC protocol used to communicate the RAU Request message.

For the PS domain to CS domain SRVCC of FIG. 3, the MS 100 necessarily experiences an inter-RAT handover. In one non-limiting embodiment, the MS 100 receives (block 308) the SI communicated (transmitted) by the target UTRAN 110/GERAN 120 (block 306) on the FACCH. The MS 100 determines (block 310) that inter-RAT handover has occurred (E-UTRAN PS domain to UTRAN/GERAN CS domain), and further determines (block 312) that the target UTRAN 110/GERAN 120 and MS 100 are DTM capable. The MS 100 determines (block 314) from occurrence of inter-RAT handover and that the target UTRAN 110/GERAN 120 and MS 100 are DTM capable, that it shall perform a RAU to update the PS domain.

Thus, for example, following the handover process from the E-UTRAN 130 to the GERAN 120, the MS 100 has been handed over from the PS domain to the CS domain. The MS 100 determines that inter-RAT has occurred and that it and the GERAN 120 are both Dual Transfer Mode (DTM) capable. Therefore, although the MS 100 is in a GSM call, it establishes an uplink Temporary Block Flow (TBF) in the PS domain of the new cell to perform a RAU to update the PS domain.

When the MS 100 transmits a RAU Request message in the new cell, the target UTRAN 110/GERAN 120 is then responsible for forwarding the RAU Request message to the correct SGSN based on the PLMN ID that was selected (e.g. selected by the serving E-UTRAN core network) during the PS handover procedure. Note that the PLMN ID index corresponding to the selected PLMN ID is used by the MS 100 upon its arrival in the new cell (i.e. the SGSN to which the target UTRAN 110/GERAN 120 forwards the RAU Request message shall be associated with the selected PLMN ID).

In the embodiment of FIG. 3, the MS 100 communicates (block 316) the RAU Request message toward the target UTRAN 110/GERAN 120. The RAU Request message is sent from the MS 100 using one or more RLC data blocks where, to help the target UTRAN 110/GERAN 120 with its routing process, the PLMN ID index can be embedded in a header of the first RLC data block of the RLC protocol used to communicate the RAU Request message.

The target UTRAN 110/GERAN 120 receives (block 318) the RAU Request message from the MS 100, and identifies PLMN ID index carried by the RLC protocol used to communicate the RAU Request message (e.g., within the header of the first RLC data block), and determines (block 320) that the MS 100 is DTM capable (and further determines that it is itself DTM capable). Responsive to determining DTM capability, the target UTRAN 110/GERAN 120 selects (block 322), based on the PLMN ID index carried by the RLC protocol used to communicate the RAU Request message, one of the PLMN IDs that is transmitted as SI on the BCCH. As explained above, the set of the PLMN IDs can be an ordered list of PLMN IDs, and the PLMN ID index can identify a location of the PLMN ID in the ordered list of PLMN IDs that is to be selected (block 322).

Responsive to positively determining DTM capability and selected one of the PLMN IDs, the target UTRAN 110/GERAN 120 forwards (block 324) the RAU Request message to one of the SGSNs 140 that is identified based on the selected one of the PLMN IDs.

Accordingly, the PLMN ID index carried by the RLC protocol used to communicate the RAU Request message provides the target UTRAN 110/GERAN 120 with a value that it uses, when it gets the complete set of RLC data blocks containing the RAU Request message, to determine the SGSN associated with the PLMN ID Index to which it is to forward the RAU Request message.

In another embodiment, for non-handover based entry into a given serving cell where MOCN is supported (where the MS 100 enters via reselection into a MOCN capable cell), the MS 100 can have knowledge of the set of available PLMNs based on reading SI sent in that cell. After reading SI, the MS 100 is therefore able to select one of these PLMNs and set the value of the PLMN ID index carried within the first RLC data block to reflect the selected PLMN.

Still other embodiments are directed to controlling handover of the MS 100 from a source UTRAN 110′ cell or source GERAN 120′ cell in the CS domain to a target UTRAN 110″ cell or target GERAN 120″ cell in the CS domain. The operations, methods and associated message flows illustrated in FIG. 2 may similarly be performed to initiate CS to CS handover, with the MS 100 receiving a handover command that includes the PLMN ID index for the target UTRAN 110″ or target GERAN 120″ in the CS domain. However, the further process by the MS 100 and the target UTRAN 110″/GERAN 120″ is different from FIG. 3, instead following the operations, methods and associated message flows of FIG. 4.

Referring to FIG. 4, the MS 100 receives (block 400) the handover command from the source UTRAN 110′/GERAN 120′ containing the PLMN ID index, and executes handover (block 402) by moving to the indicated target UTRAN 110″/GERAN 120″ cell and communicating therewith. The target UTRAN 110/GERAN 120 detects (block 404) arrival of the MS 100.

The MS 100 determines (block 412) whether a RAU is needed, and, if so, communicates (block 414) a RAU Request message toward the target UTRAN 110″/GERAN 120″ wherein the supporting RLC protocol carries the PLMN ID index.

In contrast to the PS domain to CS domain SRVCC of FIG. 3 where the MS 100 performs RAU responsive to experiencing an inter-RAT handover, for the CS domain to CS domain handover of FIG. 4 (e.g., from a source GERAN′/UTRAN′ cell to a target GERAN″/UTRAN″ cell), upon arriving in the new cell the MS 100 determines whether a RAU is needed once the CS handover is complete. In an embodiment of the present disclosure, this determination is performed based on information the MS 100 receives in SI transmitted using the FACCH by the target UTRAN 110″/GERAN 120″.

With continuing reference to FIG. 4, the target UTRAN 110″/GERAN 120″ uses the FACCH to communicate (block 406) System Information (SI) containing the selected PLMN ID and the corresponding Routing Area Code (RAC). In a further non-limiting embodiment, the selected PLMN ID and the RAC are communicated (block 406) in system information 6 (SI6) message sent on the FACCH.

In one non-limiting embodiment, the MS 100 can receive (block 408) the RAC in the SI sent using FACCH and, in a further non-limiting embodiment, information in SI6 sent on the FACCH which includes the value for the RAC, and which the MS 100 uses to determine if it needs to perform a RAU. The MS 100 can determine (block 409) that the MS 100 and the target UTRAN 110″/GERAN 120″ is Dual Transfer Mode (DTM) capable and, if so, can respond to detection of a new RAC, which is a RAC that is different from a RAC associated with its registered Routing Area Identity (RAI) established by the MS 100 before the handover, by triggering a RAU.

For example, after the MS 100 performs a CS to CS handover and while in a CS call, the MS 100 receives via FACCH a SI6 which is sent to the MS 100 in response to the MS 100 arriving in the target UTRAN 110″/GERAN 120″ cell. Based on the determination of block 409 finding that the MS 100 and target UTRAN 110″/GERAN 120″ are DTM capable, the MS 100 compares (block 410) the registered Routing Area Identification (RAI) of the MS to the selected RAI, where the selected RAI is determined using the values of the selected PLMN ID and the corresponding RAC indicated by the SI6. Further to the determination of DTM capability (block 409), the MS 100 determines (block 412) that a RAU is needed if the registered RAI of the MS 100 is different from the selected RAI.

The SI sent using the FACCH can include a LAC and the selected PLMN which are combined with the RAC to form a Routing Area Identity (RAI). The MS 100 may use the RAI to determine whether to perform a RAU. Following handover, when the MS 100 detects a RAI associated with the new cell (i.e. the selected RAI) that is different from the RAI it is currently registered for, the difference causes the MS 100 to perform a RAU.

Responsive to the determination (block 412), the MS 100 performs a RAU by transmitting a RAU Request message in the new cell, the target UTRAN 110″/GERAN 120″ is then responsible for forwarding the RAU Request message to the correct SGSN based on the PLMN ID that was selected (e.g. selected by the serving UTRAN 110′/GERAN 120′) during the CS handover procedure. Note that the PLMN ID index is used by the MS 100 upon its arrival in the new cell by including it in the RLC protocol used to communicate the RAU Request message (i.e. the SGSN to which the target UTRAN 110″/GERAN 120″ forwards the RAU Request message shall be associated with the selected PLMN ID which is the PLMN ID corresponding to the PLMN ID index indicated by the RLC protocol).

In the embodiment of FIG. 4, the MS 100 communicates (block 414) the RAU Request message toward the target UTRAN 110″/GERAN 120″ using the RLC protocol which carries the PLMN ID index. The RAU Request message is sent from the MS 100 using one or more RLC data blocks where, to help the target UTRAN 110″/GERAN 120″ with its routing process, the PLMN ID index can be embedded in a header of the first RLC data block of the RLC protocol used to communicate the RAU Request message.

The target UTRAN 110″/GERAN 120″ receives (block 416) the RAU Request message from the MS 100, and identifies the PLMN ID index carried by the RLC protocol used to communicate the RAU Request message (e.g., within the header of the first RLC data block). The target UTRAN 110″/GERAN 120″ knows that it and the MS 100 are DTM capable. The target UTRAN 110″/GERAN 120″ selects (block 420), based on the PLMN ID index carried by the RLC protocol used to communicate the RAU Request message, one of the PLMN IDs that is transmitted as SI on the BCCH. As explained above, the set of the PLMN IDs can be an ordered list of PLMN IDs, and the PLMN ID index can identify a location of the PLMN ID in the ordered list of PLMN IDs that is to be selected (block 420).

Responsive to positively determining DTM capability and selecting one of the PLMN IDs, the target UTRAN 110″/GERAN 120″ forwards (block 422) the RAU Request message to one of the SGSNs 140 that is identified based on the selected one of the PLMN IDs.

Accordingly, the PLMN ID index is carried by the RLC protocol used to communicate the RAU Request message provides the target UTRAN 110″/GERAN 120″ with a value that it uses, when it gets the complete set of RLC data blocks containing the RAU Request message, to determine the SGSN associated with the PLMN ID Index to which it is to forward the RAU Request message.

### Example Radio Access Network Node and Mobile Station

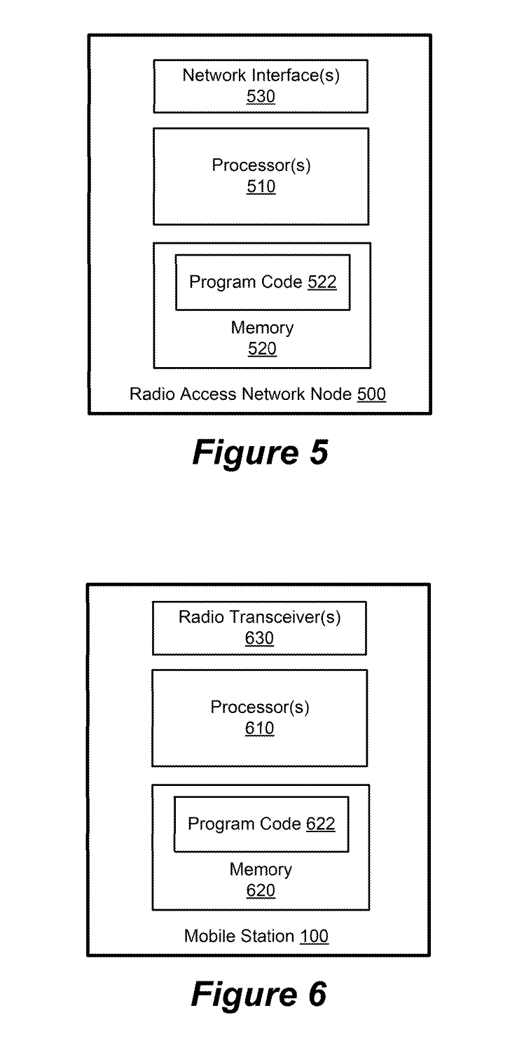

FIG. 5 is a block diagram of a RAN node 500 that is configured according to some embodiments. The RAN node 500 may be used as one or more of the elements of FIGS. 1-4, including, but not limited, to the UTRAN 110, the GERAN 120, and E-UTRAN 130. The RAN node 500 can include one or more network interfaces 530, processor circuitry (“processor”) 510, and memory 520 containing program code 522.

The processor 510 may include one or more data processing circuits, such as a general purpose and/or special purpose processor (e.g., microprocessor and/or digital signal processor) that may be collocated or distributed across one or more networks. The processor 510 is configured to execute program code 522 in the memory 520, described below as a computer readable medium, to perform some or all of the operations and methods that are described above for one or more of the embodiments, such as the embodiments of FIGS. 1-4. Accordingly, the processor 510 can be configured by execution of the program code 522 to carry out at least some of the functionality disclosed herein to control PS domain to CS domain SRVCC and/or CS domain to CS domain handover.

FIG. 6 is a block diagram of a MS 100 that is configured according to some embodiments. The MS 100 may be used as the MS 100 of FIGS. 1-4. The MS 100 can include one or more radio transceivers 630, processor circuitry (“processor”) 610, and memory 620 containing program code 622.

The processor 610 may include one or more data processing circuits, such as a general purpose and/or special purpose processor (e.g., microprocessor and/or digital signal processor) that may be collocated or distributed across one or more networks. The processor 610 is configured to execute program code 622 in the memory 620, described below as a computer readable medium, to perform some or all of the operations and methods that are described above for one or more of the embodiments, such as the embodiments of FIGS. 1-4. Accordingly, the processor 610 can be configured by execution of the program code 622 to carry out at least some of the functionality disclosed herein to control PS domain to CS domain SRVCC and/or CS domain to CS domain handover.

### Abbreviations:

A list of abbreviations used in the present disclosure is provided below for ease of reference of the reader:
3GPP Third Generation Partnership Project
ARP Allocation and Retention Priority
BCCH Broadcast Control Channel
BSC Base Station Controller
BSS Base Station Subsystem
CS Circuit Switched
CSFB Circuit Switched Fall Back
EDGE Enhanced Data rates for GSM Evolution
EPS Evolved Packet System
E-UTRAN Evolved Universal Terrestrial Radio Access Network
eNodeB E-UTRAN NodeB
FACCH Fast Associated Control Channel
FULL-MOCN FULL-Multi-Operator Core Network
GERAN GSM EDGE Radio Access Network
GPRS General Packet Radio Service
GWCN Gateway Core Network
IE Information Element
IMS IP Multimedia Subsystem
LAU Location Area Update
MME Mobility Management Entity
MS Mobile Station
MSC Mobile Switching Centre
PLMN Public Land Mobile Network
PS Packet Switched
RAI Routing Area Identity
RAT Radio Access Technology
RAN Radio Access Network
RAU Routing Area Update
RLC Radio Link Control
RNC Radio Network Controller
RNS Radio Network Subsystem
SGSN Serving GPRS Support Node
SGW Serving Gateway
SI System Information
SRVCC Single Radio Voice Call Continuity
STN-SR Session Transfer Number for SRVCC
UMTS Universal Mobile Telecommunications System
UTRAN UMTS Terrestrial Radio Access Network

### Further Definitions and Embodiments

In the above-description of various embodiments of the present disclosure, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present disclosure may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination.

Many variations and modifications can be made to the embodiments without substantially departing from the principles of the present invention. All such variations and modifications are intended to be included herein within the scope of the present invention.

1. A method by a target Universal Terrestrial Radio Access Network (UTRAN) or target GSM EDGE Radio Access Network (GERAN) operating in circuit switched (CS) domain to control handover of a mobile station (MS) from a source Radio Access Network (RAN), the method comprising the steps of:
receiving a handover request message from a MSC server as a result of handover triggered by the source RAN, the handover request message identifying a selected Public Land Mobile Network (PLMN) identity (ID) that will serve the MS after handover;
generating a PLMN ID index that indicates an association between the selected PLMN ID and one of a plurality of PLMN IDs of a set transmitted as system information by the target UTRAN or target GERAN on a Broadcast Control Channel (BCCH); and
communicating a handover response containing the PLMN ID index toward the MSC server for subsequent forwarding to the MS by the source RAN.

2. The method of claim 1, wherein the step of receiving the handover request message comprises:
determining the selected PLMN ID from a target cell ID contained in the handover request message.

3. The method of claim 1, wherein:
the set of the PLMN IDs comprises an ordered list of PLMN IDs; and
the PLMN ID index is generated based on a location of the selected PLMN ID in the ordered list of PLMN IDs.

4. The method of claim 1, wherein the PLMN ID index identifies a PLMN ID corresponding to one of a plurality of different operators of a FULL-Multi-Operator Core Network (FULL-MOCN) that is serving the MS.

5. The method of claim 1, wherein the handover response comprises a handover request acknowledgement containing the PLMN ID index.

6. The method of claim 5, wherein the step of communicating the handover response containing the PLMN ID index toward the MSC server for subsequent forwarding to the MS comprises embedding the PLMN ID index in a transparent container carried within the handover request acknowledgement.

7. The method of claim 1, wherein generating the PLMN ID index, comprises:
determining that the MS is Dual Transfer Mode (DTM) capable as a precondition for generating the PLMN ID index.

8. The method of claim 1, further comprising the steps of:
detecting the MS during a handover process; and
responsive to the detecting, communicating the selected PLMN ID and the corresponding Routing Area Code (RAC) in the system information transmitted by the target UTRAN or target GERAN.

9. The method of claim 8, wherein the RAC is communicated in the system information 6 (SI 6) message sent on a Fast Associated Control Channel (FACCH).

10. The method of claim 1, further comprising the steps of:
receiving a Routing Area Update (RAU) request message from the MS, the RLC protocol used to communicate the RAU Request message containing the PLMN ID index;
selecting, based on the PLMN ID index, one of the PLMN IDs transmitted as system information by the target UTRAN or target GERAN using a Fast Associated Control Channel (FACCH); and
forwarding the RAU Request message to a Serving GPRS Support Node (SGSN) that is identified based on the PLMN ID index.

11. The method of claim 10, wherein the step of receiving comprises the step of:
identifying the PLMN ID index within a header of a first Radio Link Control (RLC) data block of the RLC protocol used to communicate the RAU Request message.

12. A method by a mobile station (MS) for controlling handover from a source Radio Access Network (RAN) to a target Universal Terrestrial Radio Access Network (UTRAN) or target GSM EDGE Radio Access Network (GERAN) operating in circuit switched (CS) domain, the method comprising the steps of:
receiving a handover command from the source RAN, the handover command containing a PLMN ID index;
executing handover to the target UTRAN or target GERAN;
determining that a routing area update (RAU) is needed; and
communicating a RAU Request message toward the target UTRAN or target GERAN with the PLMN ID index carried by a RLC protocol used to communicate the RAU Request message.

13. The method of claim 12, wherein the step of receiving the handover command comprises:
identifying the PLMN ID index carried within the handover command.

14. The method of claim 12, wherein the step of determining that a routing area update (RAU) is needed comprises the steps of:
receiving system information transmitted by the target UTRAN or target GERAN on the FACCH;
determining that inter-Radio Access Technology (RAT) handover has occurred; and
determining that MS and target GERAN is Dual Transfer Mode (DTM) capable,
wherein the RAU is determined to be needed based on inter-RAT handover being ongoing and based on MS and target GERAN both being Dual Transfer Mode (DTM) capable.

15. The method of claim 12, wherein the step of determining (412) that a routing area update (RAU) is needed comprises the steps of:
receiving system information transmitted by the target UTRAN or target GERAN, the system information containing the selected PLMN ID and the corresponding Routing Area Code (RAC); and
comparing a selected RAI, determined using the selected PLMN ID and the corresponding RAC from the system information, to a registered RAI of the MS established before the handover was executed,
wherein the RAU is determined to be needed based on the selected RAI being different from the registered RAI established before the handover was executed and based on the MS and the target UTRAN or target GERAN being Dual Transfer Mode (DTM) capable.

16. The method of claim 15, wherein the selected PLMN ID and the corresponding RAC are received in the system information 6 (SI6) message sent on a Fast Associated Control Channel (FACCH).

17. The method of claim 12, wherein the step of communicating the RAU Request message comprises the step of:
embedding the PLMN ID index within a header of a first Radio Link Control (RLC) data block of the RLC protocol used to communicate the RAU Request message.

18. The method of claim 12, wherein the PLMN ID index identifies a PLMN ID corresponding to one of a plurality of different operators of a FULL-Multi-Operator Core Network (FULL-MOCN) that is serving the MS.

19. The method of claim 12, wherein the PLMN ID index identifies a location of a PLMN ID in an ordered list of PLMN IDs transmitted as system information by the target UTRAN or target GERAN on a Broadcast Control Channel (BCCH).

20. A target Universal Terrestrial Radio Access Network (UTRAN) or target GSM EDGE Radio Access Network (GERAN) node operating in circuit switched (CS) domain for controlling handover of a mobile station from a source Radio Access Network (RAN), comprising:
at least one processor; and
at least one memory coupled to the at least one processor and comprising computer readable program code that when executed by the at least one processor causes the at least one processor to perform operations comprising:
receiving a handover request message from the MSC server as a result of handover triggered by the source RAN, the handover request message identifying a selected Public Land Mobile Network (PLMN) identity (ID) that will serve the MS after handover;
generating a PLMN ID index that indicates an association between the selected PLMN ID and one of a plurality of PLMN IDs of a set transmitted as system information by the target UTRAN or target GERAN on the BCCH; and
communicating a handover response containing the PLMN ID index toward the MSC server for subsequent forwarding to the MS by the source RAN.

21. The target Universal Terrestrial Radio Access Network (UTRAN) or target GSM EDGE Radio Access Network (GERAN) node of claim 20, wherein the computer readable program code when executed by the at least one processor causes the at least one processor to perform operations comprising:
determining the selected PLMN ID from a target cell ID contained in the handover request message.

22. The target Universal Terrestrial Radio Access Network (UTRAN) or target GSM EDGE Radio Access Network (GERAN) node of claim 20, wherein:
the set of the PLMN IDs comprises an ordered list of PLMN IDs; and
the PLMN ID index is generated based on a location of the selected PLMN ID in the ordered list of PLMN IDs.

23. The target Universal Terrestrial Radio Access Network (UTRAN) or target GSM EDGE Radio Access Network (GERAN) node of claim 20, wherein the PLMN ID index identifies a PLMN ID corresponding to one of a plurality of different operators of a FULL-Multi-Operator Core Network (FULL-MOCN) that is serving the MS.

24. The target Universal Terrestrial Radio Access Network (UTRAN) or target GSM EDGE Radio Access Network (GERAN) node of claim 20, wherein the handover response comprises a handover request acknowledgement containing the PLMN ID index.

25. The target Universal Terrestrial Radio Access Network (UTRAN)) or target GSM EDGE Radio Access Network (GERAN) node of claim 24, wherein:
the communicating the handover response containing the PLMN ID index toward the MSC server for subsequent forwarding to the MS comprises embedding the PLMN ID index in a transparent container carried within the handover request acknowledgement.

26. The target Universal Terrestrial Radio Access Network (UTRAN) or target GSM EDGE Radio Access Network (GERAN) node of claim 20, wherein the generating the PLMN ID index, comprises determining that the MS is Dual Transfer Mode (DTM) capable as a precondition for generating the PLMN ID index.

27. The target Universal Terrestrial Radio Access Network (UTRAN) or target GSM EDGE Radio Access Network (GERAN) node of claim 20, wherein the computer readable program code when executed by the at least one processor causes the at least one processor to perform operations comprising:
detecting the MS during a handover process; and
responsive to the detecting, communicating the selected PLMN ID and the corresponding Routing Area Code (RAC) in the system information transmitted by the target UTRAN or target GERAN.

28. The target Universal Terrestrial Radio Access Network (UTRAN) or target GSM EDGE Radio Access Network (GERAN) node of claim 27, wherein the RAC is communicated in the system information 6 (SI 6) message sent using the FACCH.

29. The target Universal Terrestrial Radio Access Network (UTRAN) or target GSM EDGE Radio Access Network (GERAN) node of claim 20, wherein the computer readable program code when executed by the at least one processor causes the at least one processor to perform operations comprising:
receiving a Routing Area Update (RAU) request message from the MS, the RLC protocol used to communicate the RAU Request message containing the PLMN ID index;
selecting, based on the PLMN ID index, one of the PLMN IDs transmitted as system information by the target UTRAN or target GERAN on the BCCH; and
forwarding the RAU Request message to a Serving GPRS Support Node (SGSN) that is identified based on the PLMN ID index.

30. The target Universal Terrestrial Radio Access Network (UTRAN) or target GSM EDGE Radio Access Network (GERAN) node of claim 29, wherein the receiving comprises identifying the PLMN ID index within a header of a first Radio Link Control (RLC) data block of the RLC protocol used to communicate the Routing Area Update (RAU) request message.

31. A mobile station (MS) for controlling handover from a source Radio Access Network (RAN) to a target Universal Terrestrial Radio Access Network (UTRAN) or target GSM EDGE Radio Access Network (GERAN) operating in circuit switched (CS) domain, comprising:
at least one processor; and
at least one memory coupled to the at least one processor and comprising computer readable program code that when executed by the at least one processor causes the at least one processor to perform operations comprising:
receiving a handover command from the source RAN, the handover command containing a PLMN ID index;
executing handover to the target UTRAN or target GERAN;
determining that a routing area update (RAU) is needed; and
communicating a RAU Request message toward the target UTRAN or target GERAN with the PLMN ID index carried by a RLC protocol used to communicate the RAU Request message.

32. The MS of claim 31, wherein the receiving the handover command comprises:
identifying the PLMN ID index carried within the handover command.

33. The MS of claim 31, wherein determining that a routing area update (RAU) is needed comprises:
receiving system information transmitted by the target UTRAN or target GERAN on the FACCH;
determining that inter-Radio Access Technology (RAT) handover has occurred; and
determining that MS and target GERAN is Dual Transfer Mode (DTM) capable,
wherein the RAU is determined to be needed based on inter-RAT handover being ongoing and based on MS and target GERAN both being Dual Transfer Mode (DTM) capable.

34. The MS of claim 31, wherein determining that a routing area update (RAU) is needed comprises:
receiving system information transmitted by the target UTRAN or target GERAN, the system information containing the selected PLMN ID and the corresponding Routing Area Code (RAC); and
comparing a selected RAI, determined using the selected PLMN ID and the corresponding RAC from the system information, to a registered RAI of the MS established before the handover was executed,
wherein the RAU is determined to be needed based on the selected RAI being different from the registered RAI established before the handover was executed and based on the MS and the target UTRAN or target GERAN being Dual Transfer Mode (DTM) capable.

35. The MS of claim 34, wherein the selected PLMN ID and the corresponding RAC are received in the system information 6 (SI6) message sent on a Fast Associated Control Channel (FACCH).

36. The MS of claim 31, wherein communicating the RAU Request message comprises:
embedding the PLMN ID index within a header of a first Radio Link Control (RLC) data block of the RLC protocol used to communicate the RAU Request message.

37. The MS of claim 31, wherein the PLMN ID index identifies a PLMN ID corresponding to one of a plurality of different operators of a FULL-Multi-Operator Core Network (FULL-MOCN) that is serving the MS.

38. The MS of claim 31, wherein the PLMN ID index identifies a location of a PLMN ID in an ordered list of PLMN IDs transmitted as system information by the target UTRAN or target GERAN on a Broadcast Control Channel (BCCH).
